(19) United States
(12) Patent Application Publication
(10) Pub. No.: US 2026/0273577 A1
(43) Pub. Date: Sep. 17, 2026

(54) Screen Basket for a Sorting Machine

(71) Applicant: Kason Corporation, Millburn, NJ (US)

(72) Inventor: Dale K. Schumann, Marion, IA (US)

(21) Appl. No.: 19/111,660

(22) PCT Filed: Sep. 13, 2023
(86) PCT No.: PCT/US2023/032626

§ 371 Date: Mar. 13, 2025

Related U.S. Application Data
(60) Provisional application No. 63/406,701, filed on Sep. 14, 2022.

(51) Int. Cl. B07B 1/24

(52) U.S. Cl. CPC B07B 1/24

(57) ABSTRACT

A screen basket includes a first screen retainer for securing a first end of a tubular screen. A plurality of rods are arranged around a perimeter of the screen basket and are secured to the first screen retainer. Each of the rods includes a threaded section spaced from the first screen retainer. The screen basket also includes a second screen retainer having a second support ring for securing a second end of the tubular screen. The second screen retainer is adjustably mounted on the plurality of rods at a distance from the first screen retainer. The screen basket also includes a plurality of elongated sleeve nuts respectively disposed on the rods for holding the second screen retainer in a tensioned position. Each sleeve nut is sized and configured to enclose the threaded section of the respective rod when the second retainer is in the tensioned position.

### CROSS REFERENCE TO RELATED APPLICATION

The present application claims priority to U.S. Provisional Application No. 63/406,701, filed on Sep. 14, 2022, the entire contents of which are herein incorporated by reference.

### BACKGROUND

Screen baskets may be used for sorting materials. For example, screen baskets may be used in centrifugal sorting machines where material is fed into the interior of the basket and a first portion of the material is moved through the screen while a second portion of the material is retained by the screen and removed at an end of the basket.

### SUMMARY

Embodiments described herein relate to screen baskets used in sorting machines.

In a first aspect, a screen basket is disclosed. The screen basket includes a first screen retainer having a first support ring for securing a first end of a tubular screen and a first lateral flange that extends radially outward from the first support ring. A plurality of rods are arranged around a perimeter of the screen basket and are secured to the lateral flange of the first screen retainer. Each of the rods includes a threaded section spaced from the first screen retainer. The screen basket also includes a second screen retainer having a second support ring for securing a second end of the tubular screen and a second lateral flange that extends radially outward from the second support ring. The second screen retainer is adjustably mounted on the plurality of rods at a distance from the first screen retainer. The screen basket also includes a plurality of elongated sleeve nuts. Each sleeve nut is respectively disposed on a rod of the plurality of rods between the first support ring of the first screen retainer and the second support ring of the second screen retainer. Each sleeve nut engages the threaded section of the respective rod and is configured to hold the second screen retainer spaced from the first retainer at a tensioned position upon tightening of the respective sleeve nut on the threaded section of the respective rod. Each sleeve nut is sized and configured to enclose the threaded section of the respective rod when the second retainer is in the tensioned position.

In another aspect, a centrifugal sorting machine is disclosed. The centrifugal sorting machine includes an input hopper configured to receive material for sorting, a sorting chamber coupled to the input hopper, and an agitator extending through the sorting chamber. A screen basket is disposed in the sorting chamber, surrounds the agitator, and is positioned to receive material from the input hopper. The screen basket includes a first screen retainer having a first support ring for securing a first end of a tubular screen and a first lateral flange that extends radially outward from the first support ring. A plurality of rods are arranged around a perimeter of the screen basket and are secured to the lateral flange of the first screen retainer. Each of the rods includes a threaded section spaced from the first screen retainer. The screen basket also includes a second screen retainer having a second support ring for securing a second end of the tubular screen and a second lateral flange that extends radially outward from the second support ring. The second screen retainer is adjustably mounted on the plurality of rods at a distance from the first screen retainer. The screen basket also includes a plurality of elongated sleeve nuts. Each sleeve nut is respectively disposed on a rod of the plurality of rods between the first support ring of the first screen retainer and the second support ring of the second screen retainer. Each sleeve nut engages the threaded section of the respective rod and is configured to hold the second screen retainer spaced from the first retainer at a tensioned position upon tightening of the respective sleeve nut on the threaded section of the respective rod. Each sleeve nut is sized and configured to enclose the threaded section of the respective rod when the second retainer is in the tensioned position.

In another aspect a method of installing a tubular screen in a screen basket is disclosed. The method includes securing a first end of the tubular screen to a first screen retainer that is mounted on a plurality of rods arranged around a perimeter of the screen basket. The method also includes securing a second end of the tubular screen to a second screen retainer that is adjustably mounted on the plurality of rods at a distance from the first screen retainer. The second screen retainer is then moved to a tensioned position. A plurality of sleeve nuts disposed on the rods are tightened so as to hold the second screen retainer in the tensioned position. Each sleeve nut engages a threaded section of a respective rod. Further, each sleeve nut encloses the threaded section of the respective rod when the second screen retainer is in the tensioned position.

These as well as other aspects, advantages, and alternatives will become apparent to those of ordinary skill in the art by reading the following detailed description with reference where appropriate to the accompanying drawings.

### BRIEF DESCRIPTION OF THE DRAWINGS

The accompanying drawings are included to provide a further understanding of the systems and methods of the disclosure, and are incorporated in and constitute a part of this specification. The drawings are not necessarily to scale, and sizes of various elements may be changed for clarity. The drawings illustrate one or more embodiment(s) of the disclosure, and together with the description serve to explain the principles and operation of the disclosure. In the drawings, similar symbols typically identify similar components, unless context dictates otherwise.

FIG. 1 is an exploded perspective view of a centrifugal sorting machine, according to an example embodiment.

FIG. 2 is a perspective view of the screen basket of the centrifugal sorting machine of FIG. 1.

FIG. 3 is a perspective view of the screen basket of FIG. 2 in an un-tensioned position, according to an example embodiment.

FIG. 4 is a perspective view of the screen basket of FIG. 2 in a tensioned position, according to an example embodiment.

FIG. 5 is a cross-sectional close up view of a portion of the screen basket of FIG. 2.

### DETAILED DESCRIPTION

The following detailed description describes various features and functions of the disclosed apparatus, machines, systems, and methods with reference to the accompanying figures. The illustrative apparatus, machines, systems, and method embodiments described herein are not meant to be limiting. It will be readily understood that certain aspects of the disclosed apparatus, machines, systems, and methods can be arranged and combined in a wide variety of different configurations, all of which are contemplated herein.

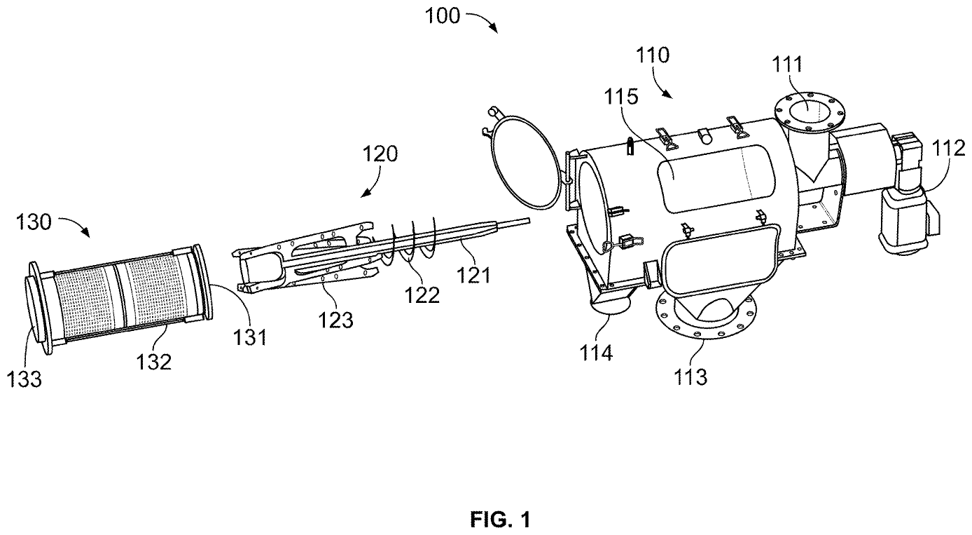

FIG. 1 is an exploded depiction of a centrifugal sorting machine 100, according to an example embodiment. The centrifugal sorting machine 100 includes a housing unit 110 containing a shaft assembly 120 and a screen basket 130. The housing unit 110 includes an input hopper 111, a sorting chamber 115, a screened outlet 113, and an un-screened outlet 114. The shaft assembly includes a drive shaft 121 driven by a motor 112, a feed screw 122, and agitator paddles 123. In this example embodiment, when assembled, the agitator paddles 123 are situated inside of the screen basket 130 which is situated inside of the sorting chamber 115 of the housing unit 110. The screen basket 130 includes a screen basket intake end 131, a sorting screen 132, and a screen basket exit end 133.

In the centrifugal sorting machine 100, unprocessed material desired for sorting initially enters the housing unit 110 of the centrifugal sorting machine 100 through the input hopper 111. For example, the unprocessed material may include solids of varying particulate size desired for sorting or sifting. The unprocessed material may also include solids combined with liquids, and separation of the solids from the liquids may be desired. The drive shaft 121 of shaft assembly 120, driven by motor 112, rotates the feed screw 122 to urge the unprocessed material through the screen basket intake end 131 into the screen basket 130. The unprocessed material is placed in communication with the sorting screen 132 through agitation by the plurality of rotating agitator paddles 123. In some embodiments, for example as shown in the embodiment of FIG. 1, the plurality of agitator paddles 123 may move material radially outward through the sorting screen 132.

In some embodiments the speed of the shaft assembly 120 may be variably adjusted to increase or decrease the rate of material entering the sorting chamber 115. Some embodiments may use agitator paddles 123 with a constant cross-sectional dimension along the longitudinal axis of the drive shaft 121, while in other embodiments the cross-sectional dimension may vary. For example, some sorting machines may use tapered agitator paddles. Further, some embodiments might employ agitator paddles 123 that run planar with the longitudinal axis of the drive shaft, while in other embodiments the agitator paddles 123 may be helically configured along the longitudinal axis of the drive shaft 121.

Material that passes through the sorting screen 132 falls downward from screen basket 130 where it exits the housing unit 110 through the screened outlet 113. On the other hand, material too large to pass through the sorting screen 132 is urged by the agitator paddles 123 to leave the screen basket 130 through the exit end 133. Once this larger material is moved out through the exit end 133 of the screen basket, it exits the housing unit 110 through the un-screened outlet 114. Sorting screens of varying pore size may be employed during operation. For example, sorting of liquid from solid particulate might use a screen pore size measured in square microns, whereas sorting solid material of varying particulate size might use a screen pore size measured in square millimeters.

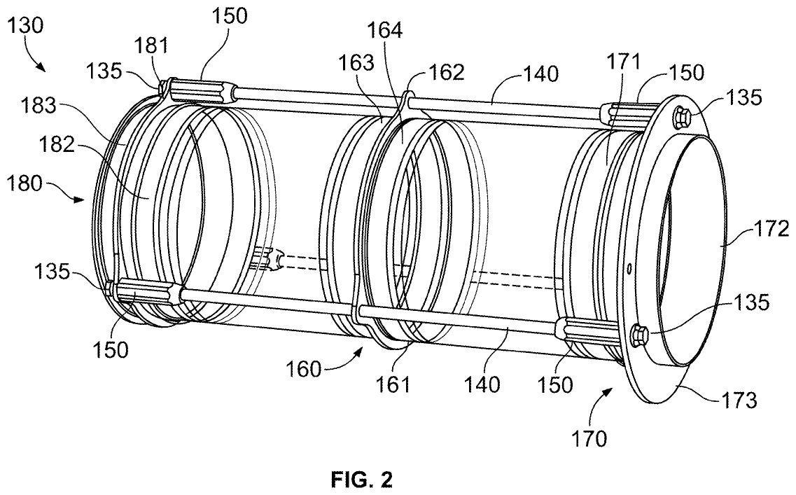

FIG. 2 illustrates a perspective view of the screen basket 130 of sorting machine 100. The screen basket 130 includes a plurality of screen retainers 160, 170, 180 that are held in a spaced apart relationship by a plurality of support rods 140 extending around the perimeter of the screen basket 130. The screen retainers are configured such that a tubular screen (FIG. 1) may be held between a pair of the screen retainers to form an inner space within the tubular screen for receiving material that is to be sorted. Further, at least one of the pair of screen retainers may be adjustable along the rods, so that the screen may be tensioned after being secured to the opposing screen retainers. For example, the screen basket may include a first screen retainer, such as a center screen retainer 160 in FIG. 2, and an adjustable second screen retainer, such as outer screen retainer 170. Further, in some embodiments, the screen basket may include additional screen retainers, such as inner screen retainer 180, which is also adjustable and disposed opposite outer screen retainer 170.

The center screen retainer 160 comprises a center retainer flange 162 and a center support ring 161. The center screen retainer 160 is connected to support rods 140 on the center retainer flange 162. The center support ring 161 has an annular groove 164 disposed on a side of the center retainer flange 162 that faces the outer screen retainer 170. The annular groove 164 is configured to receive a ring clamp for securing an end of a first tubular screen to the center screen retainer 160. The center support ring 161 has another annular groove 163 that lies on the side of the center support ring 161 between the center retainer flange 162 and the inner screen retainer 180. The annular groove 163 is configured to receive a ring clamp for securing an end of a second tubular screen to the center screen retainer 160.

The outer screen retainer 170 comprises an outer retainer flange 173 and a support ring 172. The support rods 140 mate with the outer screen retainer 170 via the retainer flange 173, and the support ring 172 is configured to receive an end of the first tubular screen. For example, the support ring 172 may include an annular groove 171 for receiving a ring clamp that holds the first tubular screen on the support ring 172.

A plurality of sleeve nuts 150 are disposed between the center screen retainer 160 and outer screen retainer 170. The plurality of sleeve nuts 150 mate with support rods 140 and the outer retainer flange 173 of the outer screen retainer 170. A plurality of end pieces 135 mate with the support rods 140 and the outer retainer flange 173, and are disposed on the face of outer retainer flange 173 opposite the plurality of sleeve nuts.

Similarly, the inner screen retainer 180 comprises an inner retainer flange 181 and a support ring 183. The support rods 140 mate with the inner screen retainer 180 via the inner retainer flange 181, and the support ring 183 is configured to receive an end of the second tubular screen. For example, the support ring 183 may include an annular groove 182 for receiving a ring clamp that holds the second tubular screen on the support ring 183. A plurality of sleeve nuts 150 are disposed between the center screen retainer 160 and inner screen retainer 180. The plurality of sleeve nuts 150 mate with support rods 140 and the inner retainer flange 181 of the inner screen retainer 180. A plurality of end pieces 135 mate with the support rods 140 and the inner retainer flange 181, and are disposed on the face of inner retainer flange 181 opposite the plurality of sleeve nuts.

While the illustrated embodiment includes annular grooves 163, 164, 171 and 182 for securing a tubular screen to the screen retainers using clamps, in other embodiments, the screens may be secured to the screen retainers using clamps without the inclusion of grooves for receiving the clamps. Further, in some embodiments, the screens may be secured to the screen retainers by another structure, such as hooks or fasteners.

In some embodiments, for example FIG. 2, the outer screen retainer 170 is adjustably mounted at the outer retainer flange 173 to one end of support rods 140 using a plurality of sleeve nuts 150 and a plurality of end pieces 135. The inner screen retainer 180 is adjustably mounted on the other end of support rods 140 at the inner retainer flange 181 using a plurality of sleeve nuts 150 and a plurality of end pieces 135. While the illustrated end pieces 135 employ hex nuts, in other embodiments the end pieces may employ other shapes and sizes capable of mating with the support rods. For example, other embodiments may use wing nuts, castle nuts, cap nuts, or lock nuts. Some embodiments may comprise removably attached end pieces 135, for example hex nuts may be used as end pieces. Other embodiments may employ irremovably attached end pieces 135, for example a welded cap may be used. The end pieces 135 may be made from a variety of material suitable for application in a particular embodiment. For example, stainless steel end pieces may be used when hygienic properties are desired. The end pieces 135 may further comprise a hygienic seal, for example an O-ring, to prevent entry of foreign material.

While the example embodiment shown in FIG. 2 depicts three support rods 140, other embodiments may employ another number of support rods 140, for example 2, 4, or 5 support rods may be used.

As illustrated in the embodiment of FIG. 2, support rods 140 pass through holes on the center retainer flange 162, coupling the center screen retainer 160 to the support rods 140. At a distance between the outer screen retainer 170 and inner screen retainer 180, for example the midpoint, support rods 140 are secured to the center screen retainer 160. This may be accomplished through tack welding of the support rods 140 to the center retainer flange 162, for example.

The example embodiment of FIG. 2 depicts screen basket 130 employing three screen retainers (outer screen retainer 170, inner screen retainer 180, and center screen retainer 160, for example). However, in other embodiments the screen basket 130 may comprise any number of screen retainers. For example, some embodiments may employ a first screen retainer and a second screen retainer. The first and second screen retainers may each respectively include a support ring for securing a first end of a tubular screen and a lateral flange that extends radially outward from the support ring. The support ring of the first and second screen retainers may further respectively include an annular groove where the tubular screen may be secured by use of a ring clamp, for example. The second screen retainer may further be adjustably mounted on the plurality of support rods at a distance from the first screen retainer.

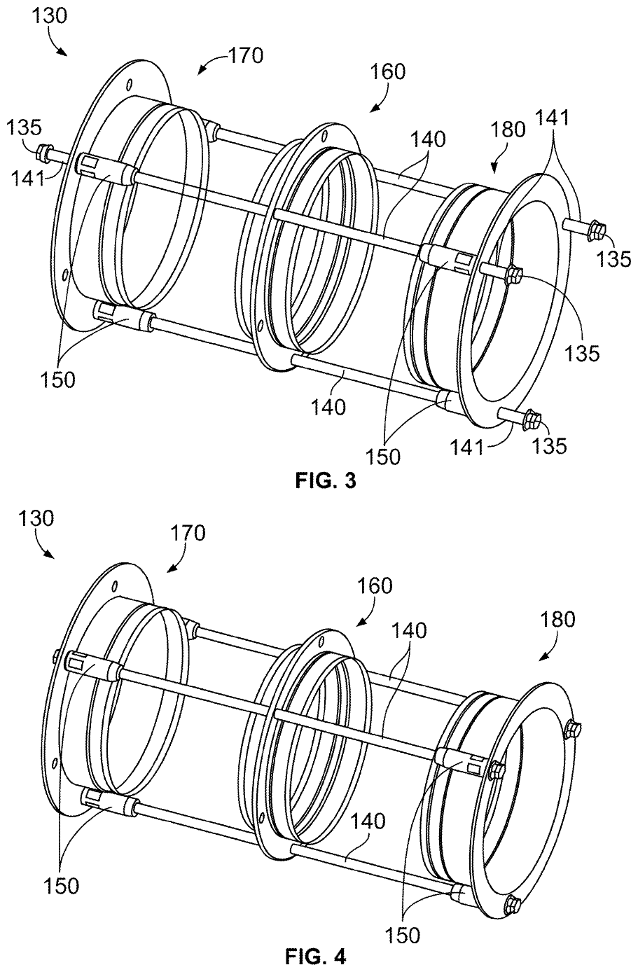

As illustrated in the example embodiment of FIG. 2, a plurality of sleeve nuts 150 are respectively disposed on support rods 140 between the center support ring 161 of the center screen retainer 160 and the outer support ring 172 of the outer screen retainer 170. As shown in FIG. 3, the plurality of sleeve nuts 150 engage the threaded section 141 of the respective support rods 140 and urge the outer screen retainer 170 away from the center screen retainer 160 to a tensioned position upon tightening of the respective sleeve nut on the threaded section 141 of the respective rod. The sleeve nut 150 is configured to enclose the threaded section of the respective support rod 140 when the outer screen retainer 170 is in the tensioned position.

Similarly, in the example embodiment of FIG. 2, a plurality of sleeve nuts 150 are respectively disposed on support rods 140 between the center support ring 161 of the center screen retainer 160 and the inner support ring 183 of the inner screen retainer 180. The plurality of sleeve nuts 150 engage the threaded section 141 of the respective support rods 140 (FIG. 3) and urge the inner screen retainer 180 away from the center screen retainer 160 to a tensioned position upon tightening of the respective sleeve nut on the threaded section 141 of the respective rod. The sleeve nut 150 is configured to enclose the threaded section of the respective support rod 140 when the inner screen retainer 180 is in the tensioned position.

FIG. 3 illustrates a perspective view of the screen basket 130 in an un-tensioned position, according to an example embodiment. In an un-tensioned position, the outer screen retainer 170 translates along support rods 140 to a position closer to center screen retainer 160 as compared to when the screen basket 130 is in a tensioned position. Further, the inner screen retainer 180 may also translate along support rods 140 to a position closer to center screen retainer 160 as compared to when the screen basket 130 is in a tensioned position. The outer screen retainer 170 may operate independently of the inner screen retainer 180 during tensioning and un-tensioning. For example, in some embodiments the outer screen retainer 170 may be in a tensioned position while the inner screen retainer 180 is in an un-tensioned position, the outer screen retainer 170 may be in an un-tensioned position while the inner screen retainer 180 is in a tensioned position, or both the outer screen retainer 170 and inner screen retainer 180 may be in an un-tensioned position. The center screen retainer 160 remains at a fixed positon during tensioning and un-tensioning. However, in other embodiments, a first screen retainer may include support rods remaining in a secured position while a second screen retainer may be adjustably mounted to support rods, allowing for a tensioned position and un-tensioned position.

Rotation of the respective sleeve nuts 150 allows for the outer screen retainer 170 and inner screen retainer 180 to translate between a constrained and unconstrained position along the support rods 140. For example, when rotation of the respective sleeve nuts 150 places the outer screen retainer 170 in an unconstrained position, the outer screen retainer 170 may be freely translated along support rods 140 to a distance closer to the center screen retainer 160 than when the outer screen retainer 170 is in a constrained position. Similarly, when rotation of the respective sleeve nuts 150 places the inner screen retainer 180 in an unconstrained position, the inner screen retainer 180 may be freely translated along support rods 140 to a distance closer to the center screen retainer 160 than when the inner screen retainer 180 is in a constrained position. In some embodiments, the level of constraint may be used to determine the level of tension in a tubular screen. For example, the screen basket 130 may be tensioned when in a constrained position and un-tensioned when in an unconstrained position.

Tension may be set by direction of rotation of the sleeve nuts 150. In some embodiments for example, rotation of sleeve nuts 150 in a clockwise direction may place the screen basket 130 in a tensioned position, while rotation of sleeve nuts 150 in a counterclockwise direction may place the screen basket 130 in an un-tensioned position. In the example embodiment of FIG. 3, a threaded section 141 of support rod 140 is visible when the screen basket 130 is in an un-tensioned position. As illustrated in the example embodiment of FIG. 3, both the inner screen retainer 180 and outer screen retainer 170 are in an un-tensioned position, exposing the threaded section 141 of support rod 140. In this particular embodiment, end pieces 135 do not change position when screen basket 130 is in a tensioned or un-tensioned position. An un-tensioned position may be desirable during screen installation or replacement, for example.

FIG. 4 illustrates a perspective view of the screen basket 130 in a tensioned position, according to an example embodiment. In the illustrated embodiment the center screen retainer 160 remains in a fixed position during tensioning, while the outer screen retainer 170 and inner screen retainer 180 may translate along the support rods 140, which may be accomplished through rotation of the sleeve nuts 150. When the outer screen retainer 170 is in a fully tensioned position, the threaded sections 141 of support rods 140 near the outer screen retainer may be enclosed within the sleeve nuts 150. Similarly when the inner screen retainer 180 is in a fully tensioned position, the threaded sections 141 of support rods 140 near the inner screen retainer may be enclosed within the sleeve nuts 150. One skilled in the art will appreciate the hygienic advantages of enclosing threaded sections 141 of support rods 140 while in a fully tensioned position. For example, enclosing the threaded sections may reduce entry of foreign material into the threaded sections during operation or reduce machine lubricants on the threaded sections from contaminating the processing material.

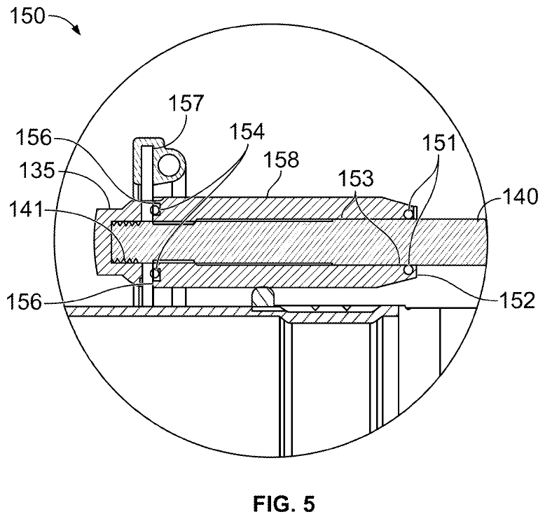

FIG. 5 illustrates a cross-sectional close up view of one sleeve nut 150 assembled on a rod 140, according to an example embodiment. In this particular embodiment the sleeve nut 150 includes an outer surface 158 and an inner surface 153, where the inner surface 153 engages the threaded section 141 of support rod 140. The sleeve nut 150 further includes an end surface 156 capable of mating with a face of a retainer flange 157 and securing the retainer flange 157 in a set position along support rod 140 while the retainer flange 157 is under tension. A first seal 151 of the sleeve nut 150 is disposed at the first end 152 of sleeve nut 150 on the inner surface 153 of sleeve nut 150 so as to engage the support rod 140. A second seal 154 is disposed at a second end 155 of sleeve nut 150 on an end surface 156 so as to engage a retainer flange 157. An end piece 135 mates with support rod 140 and lies flush with the face of retainer flange 157 opposite the end surface 156 of sleeve nut 150. The retainer flange may be that of a second screen retainer, for example.

In some embodiments, the sleeve nut 150 may be elongated to enclose the threaded section 141 of support rod 140. Further, in some embodiments, the first seal 151 and second seal 154 engage the support rod so as to hinder any material being processed from migrating between the support rod 140 and the inner surface 153 of the sleeve nut 150. This may yield numerous advantageous that may be appreciated by one skilled in the art. For example, such a seal may reduce cross-contamination between processing of differing materials. The seal may also be more hygienic, for example by reducing particulate entering, and subsequently becoming trapped, in the threaded section 141 of support rod 140. This may prove advantageous in medical or food processing applications, for example.

In some embodiments, the sleeve nuts 150 may be made from any of a variety of materials, such as stainless steel or zinc, for example. The sleeve nuts 150 may also include a corrosion protective, hygienic, or non-reactive coating.

The first and second seal may be made from a variety of different materials depending on the application of the particular embodiment. For example, the first and second seal may be made from polytetrafluoroethylene. While the first and second seal may be irremovably integrated with the sleeve nut 150, some embodiments might employ removable and replaceable seals.

Although the disclosure has been described above in connection with specific embodiments, features of one embodiment may be employed with other embodiments as the skilled artisan would recognize, even if not explicitly stated herein.

Examples given above are merely illustrative and are not meant to be an exhaustive list of all possible embodiments, applications, or modifications of the disclosure. Thus, various modifications and variations of the described machine, system, and methods will be apparent to those skilled in the art without departing from the scope and spirit of the disclosure.

Any numerical values recited herein include all values from the lower value to the upper value in increments of one unit provided that there is a separation of at least two units between any lower value and any higher value. As an example, if it is stated that the value of a variable such as, for example, size, length, flow rate and the like, is, for example, from 5 to 95, specifically from 20 to 80, more specifically from 30 to 70, it is intended that values such as 12 to 91, 24 to 60, 45 to 58, 70 to 75, etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

1. A screen basket comprising:
a first screen retainer including a first support ring for securing a first end of a tubular screen and a first lateral flange that extends radially outward from the first support ring;
a plurality of rods arranged around a perimeter of the screen basket and secured to the lateral flange of the first screen retainer, each of the rods including a threaded section spaced from the first screen retainer;
a second screen retainer including a second support ring for securing a second end of the tubular screen and a second lateral flange that extends radially outward from the second support ring, the second screen retainer being adjustably mounted on the plurality of rods at a distance from the first screen retainer;
a plurality of elongated sleeve nuts, wherein each sleeve nut is respectively disposed on a rod of the plurality of rods between the first support ring of the first screen retainer and the second support ring of the second screen retainer, wherein each sleeve nut engages the threaded section of the respective rod and is configured to hold the second screen retainer spaced from the first retainer to a tensioned position upon tightening of the respective sleeve nut on the threaded section of the respective rod, and wherein each sleeve nut is sized and configured to enclose the threaded section of the respective rod when the second retainer is in the tensioned position.

2. The screen basket of claim 1, wherein the first screen retainer has a fixed position on the rods.

3. The screen basket of claim 2, further comprising a third screen retainer adjustably mounted on the plurality of rods opposite the second screen retainer, wherein the third screen retainer includes a third support ring for securing a first end of another tubular screen, and wherein the first support ring of the first screen retainer is configured to secure a second end of the other tubular screen.

4. The screen basket of claim 1, wherein the second support ring of the second screen retainer includes an annular groove configured to receive a ring clamp for securing the tubular screen to the second support ring.

5. The screen basket of claim 1, wherein the first support ring of the first screen retainer includes an annular groove configured to receive a ring clamp for securing the tubular screen to the first support ring.

6. The screen basket of claim 1, wherein each sleeve nut includes a first seal disposed at a first end of the sleeve nut on an inner surface of the sleeve nut so as to engage the respective threaded rod.

7. The screen basket of claim 6, wherein each sleeve nut includes a second seal disposed at a second end of the sleeve nut on an end surface so as to engage the flange of the second screen retainer.

8. A centrifugal sorting machine comprising:
an input hopper configured to receive material for sorting;
a sorting chamber coupled to the input hopper;
an agitator extending through the sorting chamber; and
a screen basket disposed in the sorting chamber, surrounding the agitator, and positioned to receive material from the input hopper, wherein the screen basket comprises:
a first screen retainer including a first support ring for securing a first end of a tubular screen and a first lateral flange that extends radially outward from the first support ring;
a plurality of rods arranged around a perimeter of the screen basket and secured to the lateral flange of the first screen retainer, each of the rods including a threaded section spaced from the first screen retainer;
a second screen retainer including a second support ring for securing a second end of the tubular screen and a second lateral flange that extends radially outward from the second support ring, the second screen retainer being adjustably mounted on the plurality of rods at a distance from the first screen retainer; and
a plurality of elongated sleeve nuts, wherein each sleeve nut is respectively disposed on a rod of the plurality of rods between the first support ring of the first screen retainer and the second support ring of the second screen retainer, wherein each sleeve nut engages the threaded section of the respective rod and is configured to hold the second screen retainer spaced from the first retainer at a tensioned position upon tightening of the respective sleeve nut on the threaded section of the respective rod, and wherein each sleeve nut is sized and configured to enclose the threaded section of the respective rod when the second retainer is in the tensioned position.

9. The centrifugal sorting machine of claim 8, wherein the agitator is configured to move a first portion of the material radially outward through the screen so as to form screened material and to move a second portion of the material to an outlet end of the screen basket.

10. The centrifugal sorting machine of claim 9, wherein the agitator is disposed on a shaft and includes a plurality of agitator paddles radially extending outward from the shaft.

11. The centrifugal sorting machine of claim 9, wherein the shaft extends through the input hopper and includes a feed screw configured to move material from the input hopper into the sorting chamber.

12. The centrifugal sorting machine of claim 8, wherein the first screen retainer has a fixed position on the rods.

13. The centrifugal sorting machine of claim 12, further comprising a third screen retainer adjustably mounted on the plurality of rods opposite the second screen retainer, wherein the third screen retainer includes a third support ring for securing a first end of another tubular screen, and wherein the first support ring of the first screen retainer is configured to secure a second end of the other tubular screen.

14. The centrifugal sorting machine of claim 8, wherein the second support ring of the second screen retainer includes an annular groove configured to receive a ring clamp for securing the tubular screen to the second support ring.

15. The centrifugal sorting machine of claim 8, wherein the first support ring of the first screen retainer includes an annular groove configured to receive a ring clamp for securing the tubular screen to the first support ring.

16. The centrifugal sorting machine of claim 8, wherein each sleeve nut includes a first seal disposed at a first end of the sleeve nut on an inner surface of the sleeve nut so as to engage the respective threaded rod.

17. The centrifugal sorting machine of claim 16, wherein each sleeve nut includes a second seal disposed at a second end of the sleeve nut on an end surface so as to engage the flange of the second screen retainer.

18. A method of installing a tubular screen in a screen basket, the method comprising:
securing a first end of the tubular screen to a first screen retainer that is mounted on a plurality of rods arranged around a perimeter of the screen basket;
securing a second end of the tubular screen to a second screen retainer that is adjustably mounted on the plurality of rods at a distance from the first screen retainer;
moving the second screen retainer to a tensioned position; and
tightening a plurality of sleeve nuts disposed on the rods so as to hold the second screen retainer in the tensioned position, wherein each sleeve nut engages a threaded section of a respective rod, and wherein each sleeve nut encloses the threaded section of the respective rod when the second screen retainer is in the tensioned position.

19. The method of claim 18, wherein securing the first end of the tubular screen to the first screen retainer comprises securing a ring clamp onto the first end of the tubular screen and a support ring of the first screen retainer.

20. The method of claim 18, wherein each sleeve nut includes a first seal disposed at a first end of the sleeve nut on an inner surface of the sleeve nut so as to engage the respective threaded rod.
